(19) United States
(12) Patent Application Publication
(10) Pub. No.: US 2013/0275048 A1
(43) Pub. Date: Oct. 17, 2013

(54) METHOD OF OPERATING USER INFORMATION-PROVIDING SERVER BASED ON USERS MOVING PATTERN AND EMOTION INFORMATION

(71) Applicants: Choong Seon Hong, Yongin-si (KR); Jun Lee, Jeonju-si (KR); Rim Haw, Seoul (KR); Tae Ill Song, Seoul (KR)

(72) Inventors: Choong Seon Hong, Yongin-si (KR); Jun Lee, Jeonju-si (KR); Rim Haw, Seoul (KR); Tae Ill Song, Seoul (KR)

(73) Assignee: University-Indusrty Cooperation Group of Kyung-Hee University et al, Gyeonggi-do (KR)

(21) Appl. No.: 13/497,885

(22) PCT Filed: Aug. 25, 2011
(86) PCT No.: PCT/KR11/06266

§ 371 Date: Mar. 23, 2012

(30) Foreign Application Priority Data
Dec. 20, 2010 (KR) 10-2010-0130914

(51) Int. Cl. G06F 17/00

(52) U.S. Cl. CPC G06F 17/00
USPC 702/19

(57) ABSTRACT

The present invention relates to a method of analyzing user's behaviors based on a moving pattern of the user, and more particularly, to a method of operating a user information-providing server, in which behaviors of the user can be analyzed by providing information on user's emotion which varies depending on a moving pattern of the user, together with the moving pattern of the user, to the user or a counterpart. The inventive user information-providing server operating method provides information on user's emotion inferred using user's biological information obtained from a variety of sensors, information on a place where the user is positioned, and information on a counterpart, so that user's behaviors applicable to various fields can be accurately determined based on simple user's moving patterns and user information varying depending on the user's moving pattern. In addition, user's behaviors varying depending on the obtained counterpart information can be determined.

### TECHNICAL FIELD

The present invention relates to a method of analyzing user's behaviors based on a moving pattern of the user, and more particularly, to a method of operating a user information-providing server, in which behaviors of the user can be analyzed by providing information on user's emotion which varies depending on a moving pattern of the user, together with the moving pattern of the user, to the user or a counterpart.

### BACKGROUND ART

User's behaviors are included in a broad research target throughout the area of sociology and fall within a research field that is key in finding and delivering information that is desired by a user and is relevant to a user's situation. Researches on user's moving patterns in relation to conventional studies on user's behaviors are in active progress since the user's moving patterns are utilized for diffusion controls against contagious diseases such as H1N1 influenza or AIDS, efficient metropolitan traffic network designs, mobile communication network designs, and the like.

As social network services become popular recently, users construct human networks on the web together with the other people such as friends, acquaintances, and the like, and communicate with the people by exchanging user information such as preferred places, emotions, preferred things and the like of the user. Accordingly, conventional studies on behaviors of users based only on user's moving patterns simply show user's moving types, and the moving types are simple information that does not evaluate various external factors related to the moving patterns of the user, and thus the studies are not suitable for analyzing the user's behaviors applicable to the social network services.

### DISCLOSURE OF INVENTION

### Technical Problem

The present invention has been made to solve the above-mentioned problems associated with the prior art, and it is an object of the present invention to provide a method of operating a server, in which user information is provided so that user's behaviors varying depending on a user's moving pattern can be analyzed based on information on user's emotion inferred using user's biological information obtained from a variety of sensors, information on a place where the user is positioned, and information on a counterpart.

Another object of the present invention is to provide a method of operating a user information-providing server, in which information on a counterpart is obtained by receiving an identifier of the counterpart from a terminal of the counterpart with whom a user meets, and user information varying depending on the obtained counterpart information is transmitted to a user terminal.

Still another object of the present invention is to provide a method of operating a user information-providing server, in which a user's moving pattern and user information varying depending on the user's moving pattern are arranged on a map and edited into a context information image, and the edited context information image is transmitted to a user terminal or a counterpart terminal so that the user or the counterpart can easily determine the user information which varies depending on the user's moving pattern.

Yet another object of the present invention is to provide a method of operating a user information-providing server, in which user's behaviors can be analyzed by separately searching for only an information group mapping to user's emotion or a keyword among information groups edited based on the user's emotion or the keyword desired to be searched.

A further object of the present invention is to provide a method of operating a user information-providing server, in which information on a moving pattern, emotion and location of a user and information on a counterpart with whom the user meets are edited into one information group at regular time intervals or whenever the user's behavior is changed, and thus the information is easy to manage and edit.

### Technical Solution

To achieve the above objects, in one aspect, the present invention provides a method of operating a user information-providing server, the method including the steps of: receiving, from a user terminal, user's biological information measured by a sensor, geographic coordinate information on a place where the user is positioned, which is expressed on a surface of an ellipsoid, information on a counterpart with whom the user meets; converting the received geographic coordinate information expressed on the ellipsoidal surface into a plane rectangular coordinate, and determining location information corresponding to the converted plane rectangular coordinate from a location information database; inferring information on user's emotion from the received user's biological information; editing the location information, the emotion information and the counterpart information into one information group of a same time zone, and storing the information group in a user information database; and if a user information request message is received from the user terminal, converting the information group stored in the user information database into an image and transmitting the converted image to the user terminal.

The step of converting the information group stored in the user information database into an image and transmitting the converted image to the user terminal includes the steps of: receiving the user information request message from the user terminal; extracting an information group of the same time zone belonging to a time range from the user information database, based on time range information contained in the user information request message and desired to be searched by the user; editing the extracted information group into an context information image by arranging the information group on a map; and transmitting the edited context information image to the user terminal.

Here, the counterpart information is obtained through the steps of: receiving, by the user terminal, an identifier of the counterpart terminal from the counterpart terminal positioned at a critical distance from the user terminal and positioned within a critical distance for a threshold time period; determining, by the user terminal, the counterpart information by searching for counterpart information mapping to the identifier of the counterpart terminal from a counterpart information database provided in the user terminal or by acquiring the counterpart information contained in the identifier of the counterpart terminal; and receiving the determined counterpart information from the user terminal.

In another aspect, the present invention provides a user information-providing server comprising: a communication unit for receiving, from a user terminal, user's biological information, geographical coordinate information on a place where the user is positioned, which is expressed on a surface of an ellipsoid, information on a counterpart with whom the user meets, while communicating with the user terminal; a location information determination unit for converting the received geographical coordinate information expressed on the ellipsoidal surface into a plane rectangular coordinate, and determining location information corresponding to the converted plane rectangular coordinate from a location information database; an emotion information determination unit for determining user's emotion information by comparing the received user's biological information with information on a reference pattern stored in an emotion information database; an editing unit for editing the location information on a place where the user is positioned, the emotion information and the counterpart information into one information group of a same time zone, and storing the information group in a user information database; and a user information control unit for, if a user information request message is received from the user terminal through the communication unit, extracting an information group of the same time zone belonging to a time range from the user information database, based on information on the time range desired to be searched, creating a context information image by arranging the extracted information group on a map, and transmitting the context information image to the user terminal through the communication unit.

### Advantageous Effects

The present invention has the following advantageous effects compared with the conventional prior art.

First, the method of operating a user information-providing server according to the present invention provides information on user's emotion inferred using user's biological information obtained from a variety of sensors, information on a place where the user is positioned, and information on a counterpart, so that user's behaviors applicable to various fields can be accurately determined based on simple user's moving patterns and user information varying depending on the user's moving pattern.

Second, the method of operating a user information-providing server according to the present invention receives a counterpart identifier from the terminal of a counterpart with whom the user meets, so that the counterpart information can be easily obtained and user's behaviors varying depending on the obtained counterpart information can be determined.

Third, the method of operating a user information-providing server according to the present invention provides a user's moving pattern and user information varying depending on the user's moving pattern as a context information image arranged on a map, so that user's behaviors can be visualized and easily determined.

Fourth, the method of operating a user information-providing server according to the present invention classifies information groups by keywords (e.g., user's emotion information, counterpart information, and location information), so that user's behaviors mapping to the keywords among the information group can be determined.

Fifth, the method of operating a user information-providing server according to the present invention edits the user's moving pattern, the emotion information, the location information and information on a counterpart with whom the user meets into one information group, so that user information can be easy to manage or edit.

### BRIEF DESCRIPTION OF THE DRAWINGS

FIG. 1 is a view showing a user information-providing system according to the present invention.

FIG. 2 is a sequence diagram illustrating flow of messages transmitted and received in a user information-providing system according to the present invention.

FIG. 3 is a block diagram further specifically illustrating a user information-providing server according to the present invention.

FIG. 4 is a flowchart illustrating a method of operating a user information-providing server according to the present invention.

FIG. 5 is a view showing an example of an information group edited according to the present invention.

FIG. 6 is a view showing an example of a context information image created according to the present invention.

FIG. 7 is a flowchart further specifically illustrating the step of creating a context information image and transmitting the created context information image to a user terminal according to the present invention.

### BEST MODE FOR CARRYING OUT THE INVENTION

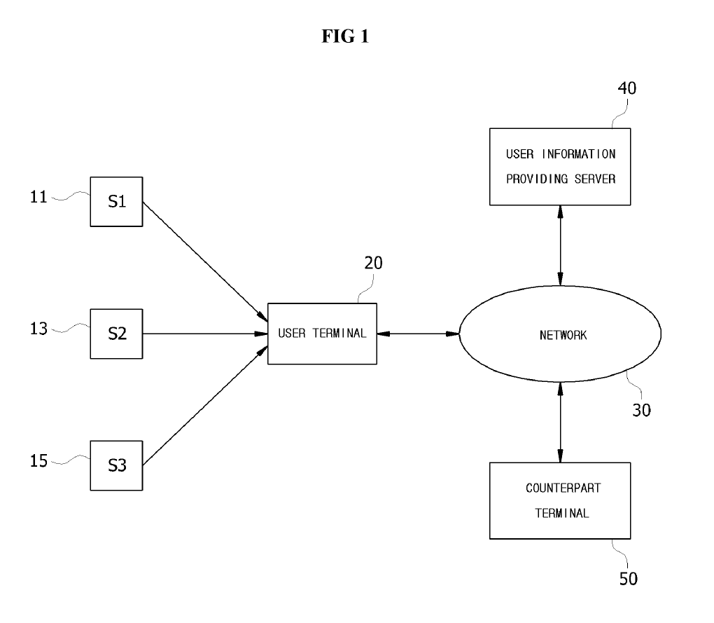

FIG. 1 is a view showing a user information-providing system according to the present invention.

The user information-providing system will be described in further detail with reference to FIG. 1.

A plurality of sensors 11, 13 and 15 is attached to a user or disposed at certain points in a place where the user is positioned and senses biological information of the user. The sensor includes a sensor module (not shown) for sensing biological information of the user and a communication module (not shown) for transmitting the sensed biological information to a user terminal 20.

The user terminal has a communication module (not shown), a coordinate determination module (not shown) and a counterpart information determination module. The communication module of the user terminal performs communications with the communication module of the sensor, and the communication module of the user terminal also connects to a network 30 and performs communications with a user information-providing server 40. Here, the Internet, Ethernet, a mobile communication network, a wired communication network or the like which connects the user terminal 20 and the user information-providing server 40 can be used as the network 30.

In the meantime the coordinate determination module of the user terminal 20 determines a geographic coordinate of a place where the user is positioned. Preferably, a GPS module installed inside the user terminal 20 can be used as the coordinate determination module of the user terminal 20. Further preferably, the coordinate determination module of the user terminal 20 determines the geographical coordinate of the user terminal 20 based on the signals received from a base station connected to the user terminal 20.

The counterpart information determination module of the user terminal 20 determines information on a counterpart by receiving an identifier of the counterpart from a counterpart terminal if the counterpart terminal and the user terminal 20 are positioned within a critical distance from each other for a predetermined threshold time period. Preferably, the user terminal 20 creates a counterpart information request message for requesting counterpart information and transmits the counterpart information request message to the counterpart terminal if the counterpart terminal is positioned within the critical distance from the user terminal for the threshold time period, and the counterpart terminal authenticates the user terminal and transmits a counterpart information response message containing an identifier of the counterpart to the user terminal only when the authentication is completed, in response to the counterpart information request message. Here, the counterpart information request message contains an identifier of the user terminal, and the counterpart terminal authenticates the user terminal and transmits the counterpart information response message to the user terminal only when the identifier of the user terminal is previously stored in the database of the counterpart terminal.

The user information-providing server 40 receives user's biological information, geographic coordinate information, counterpart information and situation information from the user terminal 20. The user information-providing server 40 determines information on user's emotion from the received user's biological information, determines information on a place where the user is positioned by converting the geographic coordinate information into a rectangular coordinate on a plane, or creates an information group containing the user's emotion information, the location information, the counterpart information and the situation information by the unit of time.

If the user information-providing server 40 receives a user information request message from the user terminal 20, the user information-providing server 40 searches for an information group corresponding to a search keyword and a search time range contained in the user information request message, visualizes the searched information group on a map and edits the information group into a context information image, and transmits the edited context information image to the user terminal 20. Preferably, if the user information-providing server 40 receives the user information request message from the counterpart terminal 50, the user information-providing server 40 authenticates whether or not the counterpart terminal 50 has a right to inquire user information based on the identifier of the counterpart terminal and transmits the context information image to the counterpart terminal 50 when the authentication is completed.

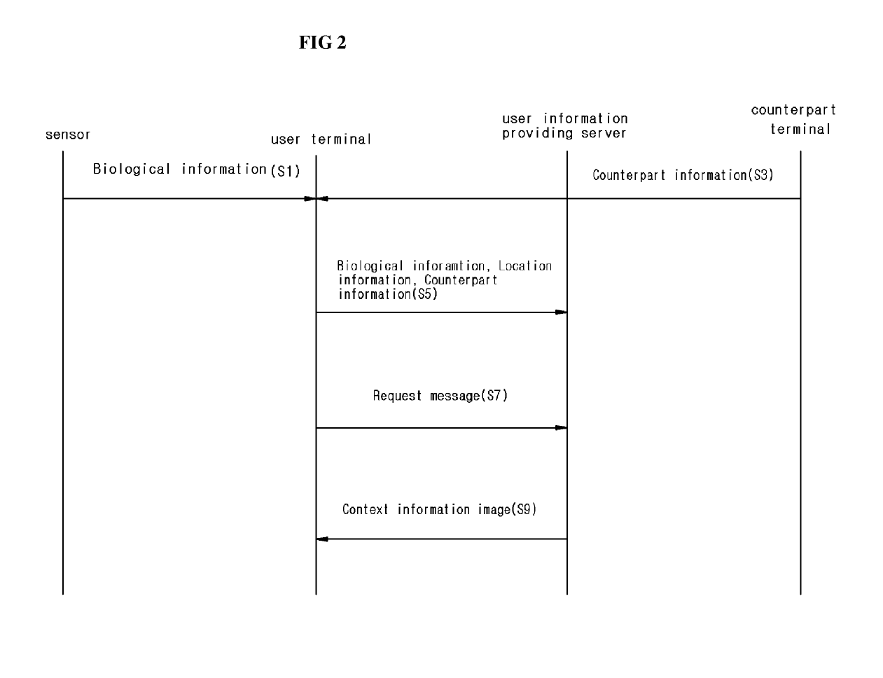

FIG. 2 is a sequence diagram illustrating flow of messages transmitted and received in a user information-providing system according to the present invention.

The flow of messages transmitted and received in a user information-providing system will be described hereinafter in further detail with reference to FIG. 2.

The sensor detects a variety of biological information of the user and transmits the sensed biological information to the user terminal (S1). Here, the biological information of the user is biological information for determining an emotional state of the user, such as a pulse rate, a blood pressure, an expression on the face, a body temperature and the like. Meanwhile, if the counterpart terminal is positioned within the critical distance for the threshold time period together with the user terminal, the counterpart terminal informs the user terminal of counterpart information by transmitting the identifier of the counterpart to the user terminal (S3). The user terminal transmits the received user's biological information and counterpart information to the user information-providing server, together with information on a geographic coordinate of the user terminal determined by the user terminal (S5).

The user information-providing server determines user's emotion information from the received user's biological information, determines location information mapping to a plane rectangular coordinate by converting the geographic coordinate of the user terminal into a plane rectangular coordinate, and creates an information group including the user's emotion information, the location information, and the counterpart information. The user terminal transmits a message for requesting user information which varies depending on a user's moving pattern to the user information-providing server (S7), and the user information-providing server creates a context information image based on an information group existing within the time range or corresponding to the keyword desired to be searched by the user and contained in the user information request message, and transmits the created context information image to the user terminal (S9).

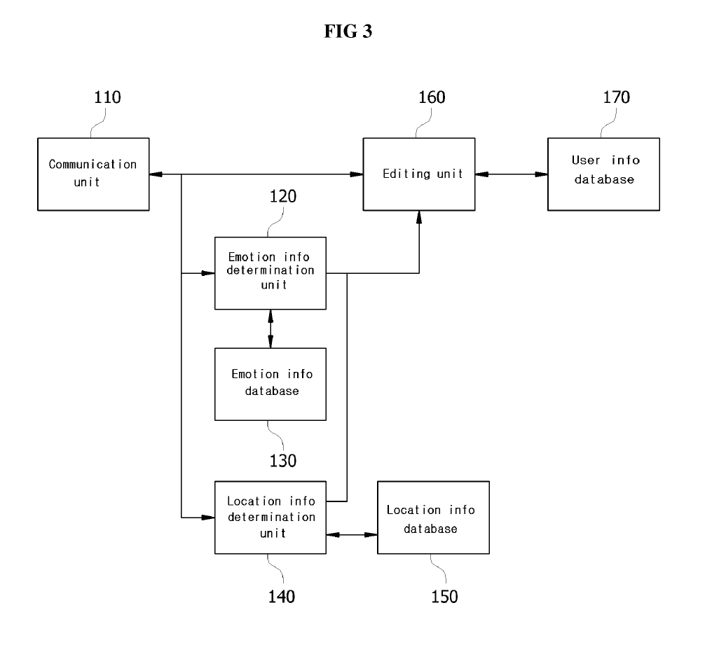

FIG. 3 is a block diagram further specifically illustrating a user information-providing server according to the present invention.

The user information-providing server will be described hereinafter in further detail with reference to FIGS. 1 and 3. If the communication unit 110 connects to the user terminal or the counterpart terminal through the network 30 and receives user's biological information, counterpart information and geographic coordinate information from the user terminal 20 or a user information request message from the user terminal 20 or the counterpart terminal 50, the communication unit 110 transmits a context information image of the user to the user terminal or the counterpart terminal in response thereto.

An emotion information determination unit 120 analyzes the user's biological information pattern using the user's biological information received through the communication unit 110, compares the analyzed user's biological information pattern with a reference biological information pattern stored in an emotion information database 130, and determines user's emotion information based on the reference biological information pattern matching to the user's biological information pattern. Here, the reference biological information pattern is the user's biological information pattern varying depending on happiness, sorrow, normal state, depression or the like.

A location information determination unit 140 converts the geographic coordinate information on a place where the user is positioned, received through the communication unit 110, into a plane rectangular coordinate and determines location information mapping to the converted plane rectangular coordinate using a location information database 150. The location information database 150 stores the rectangular coordinate and location information corresponding to the rectangular coordinate.

An editing unit 160 edits the user's emotion information and the location information determined in the same time zone and the counterpart information received through the communication unit 110 into one information group and stores the edited information group in a user information database 170. In addition, if the editing unit 160 receives a user information request message from the user terminal or the counterpart terminal through the communication unit 110, the editing unit 160 searches for a corresponding information group from the user information database 170 based on a search time range and a search keyword contained in the user information request message, and transmits the searched information group to the user terminal 20 or the counterpart terminal 50 as is through the communication unit 110, or transmits the information group to the user terminal 20 or the counterpart terminal through the communication unit 110 after editing the searched information into an image where the information group is arranged on a map, in response to the user information request message.

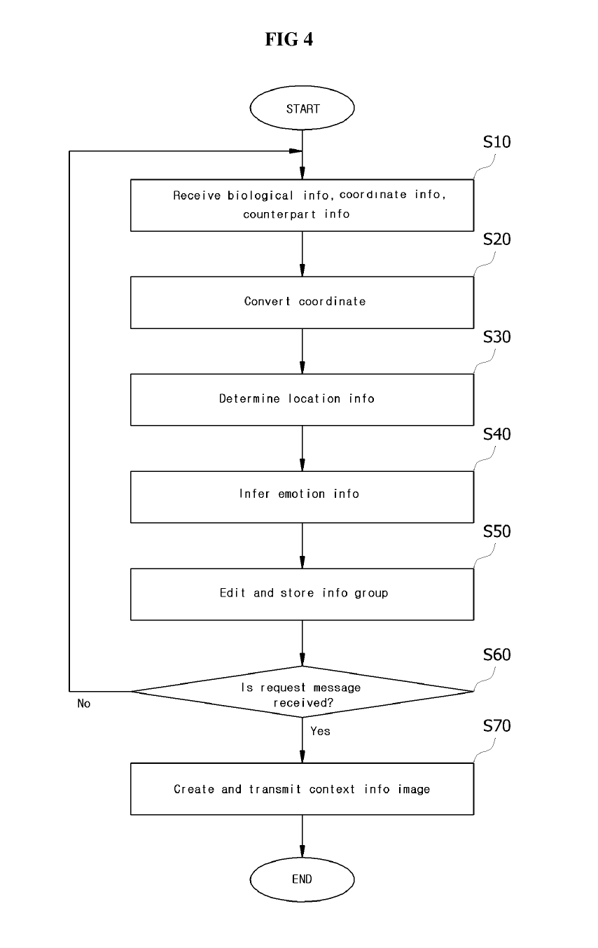

FIG. 4 is a flowchart illustrating a method of operating a user information-providing server according to the present invention.

The method of operating a user information-providing server will be described hereinafter in further detail with reference to FIG. 4. The user information-providing server receives user's biological information, geographic coordinate information and counterpart information from the user terminal (S10) and converts the received geographic coordinate information into plane rectangular coordinate information (S20). A commercial program can be used to convert the geographic coordinate information into plane rectangular coordinate information, and detailed descriptions thereof will be omitted.

The user information-providing server determines location information where the user is positioned by searching for the location information mapping to the plane rectangular coordinate from the location information database based on the converted plane rectangular coordinate (S30) and determines user's emotion information by searching for a reference biological information pattern mapping to the user's biological information pattern based on the user's biological information received from the user terminal (S40). Here, the location information, the user's emotion information and the counterpart information are determined and created by the same unit of time. Preferably, the location information is determined only when location information corresponding to the rectangular coordinate of the user is stored in the location information database.

When the location information, the user's emotion information and the counterpart information are determined by the same unit of time, the user information-providing server periodically edits the information group including the location information, the user's emotion information and the counterpart information and stores the information group into the user information database (S50). That is, the information group can be created at regular intervals, e.g., every one second, ten seconds or one minute, and a different time unit may be set depending on the field to which the present invention is applied. Preferably, the information group is created whenever the contents constructing the information group are modified, instead of editing and creating the information group at regular time intervals. That is, the information group is created whenever the location information, the user's emotion information or the counterpart information is changed.

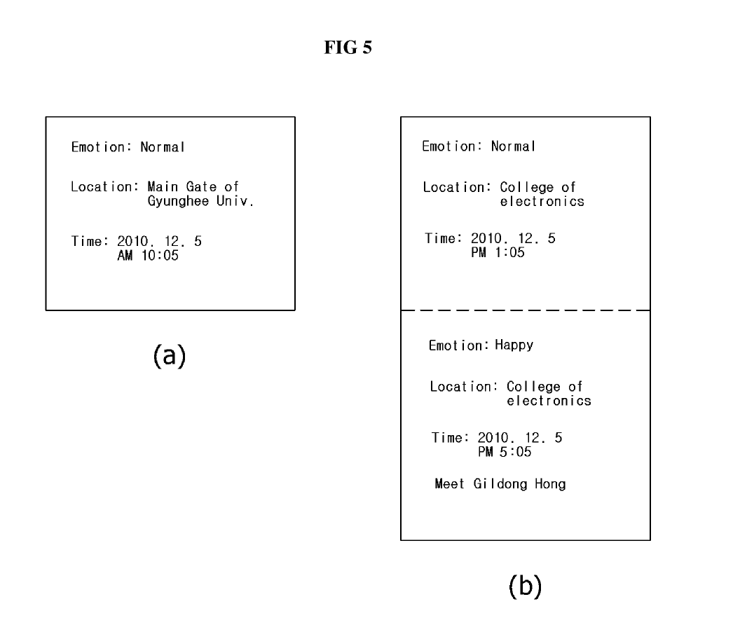

FIG. 5 is a view showing an example of an information group edited according to the present invention.

The example of the edited information group will be described hereinafter in further detail with reference to FIG. 5(a). The information group includes user's emotion information, location information and time information on the creation of the information group in the same time zone. On the other hand, describing with reference to FIG. 5(b), if the user's emotion information or the counterpart information is changed with time while the location information of the user is maintained to be the same, an information group including the user's emotion information and the counterpart information varying with time is created.

Referring back to FIG. 4, if the user information-providing server receives the user information request message from the user terminal or the counterpart terminal (S60), the user information-providing server extracts an information group corresponding to a time range or a keyword based on the time range and the keyword contained in the user information request message, creates a context information image by displaying the extracted information group on a map based on the user's moving pattern, and transmits the created context information image to the user terminal or the counterpart terminal (S70).

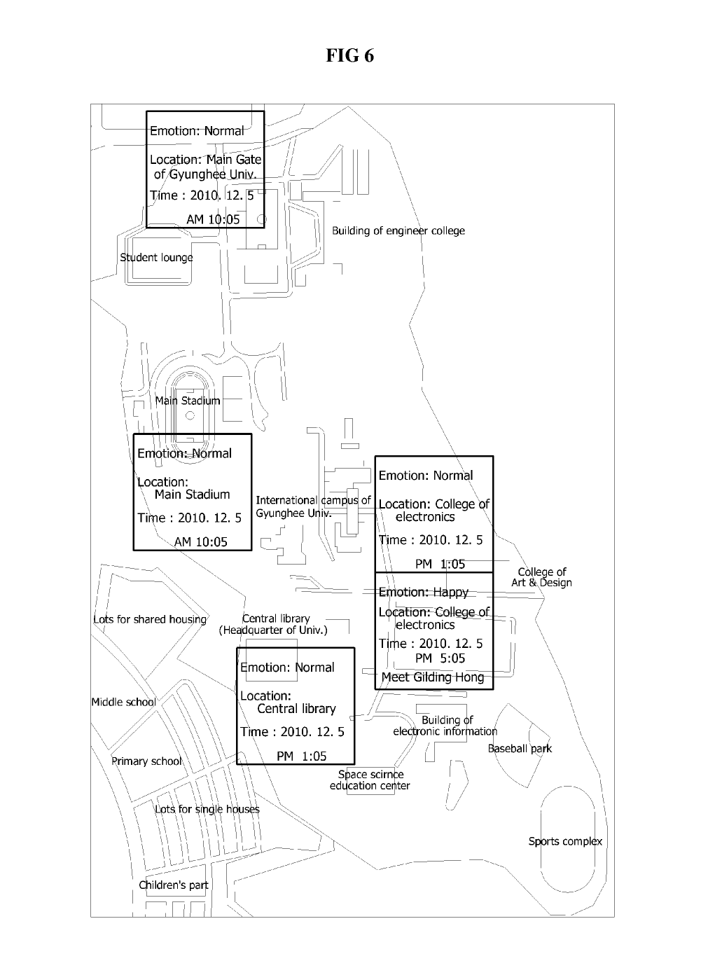

FIG. 6 is a view showing an example of a context information image created according to the present invention.

The example of the created context information image will be described hereinafter in further detail with reference to FIG. 6. An information group including a user's moving pattern and user's emotion information varying with time or including counterpart information is arranged and displayed on a map of user's moving pattern.

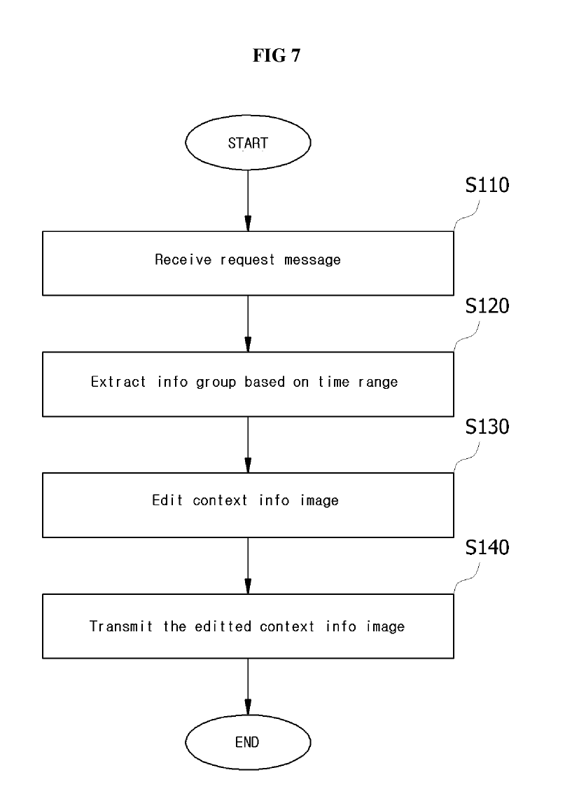

FIG. 7 is a flowchart further specifically illustrating the step of creating a context information image and transmitting the created context information image to a user terminal according to the present invention.

The step of creating a context information image and transmitting the created context information image will be described hereinafter in further detail with reference to FIG. 7. If the user information-providing server receives a user information request message from the user terminal (S110), the user information-providing server determines a search time range or a search keyword from the received user information request message, and extracts an information group corresponding to the determined search time range or search keyword from the user information database (S120). The user information-providing server searches for a map corresponding to the user's moving pattern from the extracted information group and edits a context information image by arranging the extracted group image on the searched map based on the moving pattern (S130). The edited context information image is transmitted to the user terminal (S140).

Meanwhile, the embodiments of the present invention as described above can be constructed by a computer program that can be executed in a computer and can be implemented in a general-purpose digital computer which operates the program using a computer-readable recording medium.

The computer-readable recording medium includes recording media such as magnetic storage media (e.g., ROMs, floppy disks, hard disks, and the like), optical recording media (e.g., CD-ROMs, DVDs, and the like) and carrier waves (e.g., transmission through the Internet).

While the present invention has been described in connection with the exemplary embodiments illustrated in the drawings, they are merely illustrative, and the invention is not limited to these embodiments. It is to be understood that various equivalent modifications and variations of the embodiments can be made by a person having an ordinary skill in the art without departing from the spirit and scope of the present invention. Therefore, the true technical scope of the present invention should be defined by the technical spirit of the appended claims.

1. A method of operating a user information-providing server, the method comprising the steps of:
(a) receiving, from a user terminal, user's biological information measured by a sensor, geographic coordinate information on a place where the user is positioned, which is expressed on a surface of an ellipsoid, information on a counterpart with whom the user meets;
(b) converting the received geographic coordinate information expressed on the ellipsoidal surface into a plane rectangular coordinate, and determining location information corresponding to the converted plane rectangular coordinate from a location information database;
(c) inferring information on user's emotion from the received user's biological information;
(d) editing the location information, the emotion information and the counterpart information into one information group of a same time zone, and storing the information group in a user information database; and
(e) if a user information request message is received from the user terminal, converting the information group stored in the user information database into an image and transmitting the converted image to the user terminal.

2. The method according to claim 1, wherein the counterpart information is obtained through the steps of:
receiving, by the user terminal, an identifier of the counterpart terminal from the counterpart terminal positioned at a critical distance from the user terminal and positioned within the critical distance for a threshold time period;
determining, by the user terminal, the counterpart information by searching for counterpart information mapping to the identifier of the counterpart terminal from a counterpart information database provided in the user terminal or by acquiring the counterpart information contained in the identifier of the counterpart terminal; and
receiving the determined counterpart information from the user terminal.

3. The method according to claim 2, wherein the step (e) comprises the steps of:
receiving the user information request message from the user terminal;
extracting an information group of the same time zone belonging to a time range from the user information database, based on time range information contained in the user information request message and desired to be searched by the user;
editing the extracted information group into an context information image by arranging the information group on a map; and
transmitting the edited context information image to the user terminal.

4. The method according to claim 3, wherein the information group further comprises user context information of the same time zone received from the user terminal, the user context information being inputted to the user terminal through a user interface.

5. The method according to claim 4, wherein the method further comprises:
if a search keyword is received from the user terminal, searching for an information group including the search keyword as an index term; and
converting the searched information group into an image and transmitting the converted image to the user terminal.

6. The method according to claim 1, wherein the information group of the same time zone is generated at regular time intervals or whenever at least one of information on emotion and location of the user and information on the counterpart is changed.

7. A user information-providing server comprising:
a communication unit for receiving, from a user terminal, user's biological information, geographical coordinate information on a place where the user is positioned, which is expressed on a surface of an ellipsoid, information on a counterpart with whom the user meets, while communicating with the user terminal;
a location information determination unit for converting the received geographical coordinate information expressed on the ellipsoidal surface into a plane rectangular coordinate, and determining location information corresponding to the converted plane rectangular coordinate from a location information database;
an emotion information determination unit for determining user's emotion information by comparing the received user's biological information with information on a reference pattern stored in an emotion information database;
an editing unit for editing the location information on a place where the user is positioned, the emotion information and the counterpart information into one information group of a same time zone, and storing the information group in a user information database; and
a user information control unit for, if a user information request message is received from the user terminal through the communication unit, extracting an information group of the same time zone belonging to a time range from the user information database, based on information on the time range desired to be searched, creating a context information image by arranging the extracted information group on a map, and transmitting the context information image to the user terminal through the communication unit.

8. The user information-providing server according to claim 7, wherein the counterpart information is obtained by searching for counterpart information mapping to the identifier of the counterpart terminal from a counterpart information database provided in the user terminal, based on an identifier of the counterpart terminal received from the counterpart terminal positioned at a critical distance from the user terminal and positioned within the critical distance for a threshold time period, and receiving the searched counterpart information from the user terminal.

9. The user information-providing server according to claim 8, wherein the information group of the same time zone is generated at regular time intervals or whenever at least one of information on emotion and location of the user and information on the counterpart is changed.

10. The method according to claim 2, wherein the information group of the same time zone is generated at regular time intervals or whenever at least one of information on emotion and location of the user and information on the counterpart is changed.

11. The method according to claim 3, wherein the information group of the same time zone is generated at regular time intervals or whenever at least one of information on emotion and location of the user and information on the counterpart is changed.

12. The method according to claim 4, wherein the information group of the same time zone is generated at regular time intervals or whenever at least one of information on emotion and location of the user and information on the counterpart is changed.

13. The method according to claim 5, wherein the information group of the same time zone is generated at regular time intervals or whenever at least one of information on emotion and location of the user and information on the counterpart is changed.
